(19) United States
(12) Patent Application Publication
(10) Pub. No.: US 2024/0303463 A1
(43) Pub. Date: Sep. 12, 2024

(54) NEURAL NETWORK MODEL PARTITIONING IN A WIRELESS COMMUNICATION SYSTEM

(71) Applicant: QUALCOMM Incorporated, San Diego, CA (US)

(72) Inventors: Kyle Chi GUAN, New York, NY (US); Hong Cheng, Basking Ridge, NJ (US); Qing Li, PRINCETON JUNCTION, NJ (US); Kapil Gulati, Belle Mead, NJ (US); Himaja Kesavareddigari, Bridgewater, NJ (US); Mahmoud Ashour, San Diego, CA (US)

(21) Appl. No.: 18/179,629

(22) Filed: Mar. 7, 2023

(51) Int. Cl. G06N 3/04; G06N 3/08; H04W 24/08

(52) U.S. Cl. CPC G06N 3/04; G06N 3/08; H04W 24/08

(57) ABSTRACT

Methods, systems, and devices for wireless communication are described. A first device may select a partition layer for partitioning a neural network model between the first device and a second device. The first device may implement a first sub-neural network model that includes the partition layer and the second device may implement a second sub-neural network model that includes a layer adjacent to the partition layer.

### FIELD OF TECHNOLOGY

The following relates to wireless communication, including neural network model partitioning in a wireless communication system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a device may support a neural network model that the device trains and then uses to perform various tasks. Improved techniques for implementing neural network models may be desired.

### SUMMARY

The described techniques relate to improved methods, systems, devices, and apparatuses that support neural network model partitioning in a wireless communication system. For example, the described techniques provide for a first device to determine to partition a neural network model between the first device and a second device. The first device may select a partition layer for portioning the neural network into a first sub-neural network for implementation by the first device and a second sub-neural network for implementation by the second device. The first device may select the partition layer based on performance information (e.g., latency information, power consumption information) associated with different candidate partition layers for partitioning the neural network model.

A method for wireless communication at a first device is described. The method may include obtaining first performance information of the first device associated with different candidate partition layers for partitioning a neural network model into a first sub-neural network model on the first device and a second sub-neural network model on a second device, receiving second performance information of the second device associated with the different candidate partition layers for partitioning the neural network model, and selecting, based on the first performance information and the second performance information, a candidate partition layer of the different candidate partition layers for partitioning the neural network model into the first sub-neural network model on the first device and the second sub-neural network model on the second device.

An apparatus for wireless communication at a first device is described. The apparatus may include a processor, memory coupled with the processor, and instructions stored in the memory. The instructions may be executable by the processor to cause the apparatus to obtain first performance information of the first device associated with different candidate partition layers for partitioning a neural network model into a first sub-neural network model on the first device and a second sub-neural network model on a second device, receive second performance information of the second device associated with the different candidate partition layers for partitioning the neural network model, and select, based on the first performance information and the second performance information, a candidate partition layer of the different candidate partition layers for partitioning the neural network model into the first sub-neural network model on the first device and the second sub-neural network model on the second device.

Another apparatus for wireless communication at a first device is described. The apparatus may include means for obtaining first performance information of the first device associated with different candidate partition layers for partitioning a neural network model into a first sub-neural network model on the first device and a second sub-neural network model on a second device, means for receiving second performance information of the second device associated with the different candidate partition layers for partitioning the neural network model, and means for selecting, based on the first performance information and the second performance information, a candidate partition layer of the different candidate partition layers for partitioning the neural network model into the first sub-neural network model on the first device and the second sub-neural network model on the second device.

A non-transitory computer-readable medium storing code for wireless communication at a first device is described. The code may include instructions executable by a processor to obtain first performance information of the first device associated with different candidate partition layers for partitioning a neural network model into a first sub-neural network model on the first device and a second sub-neural network model on a second device, receive second performance information of the second device associated with the different candidate partition layers for partitioning the neural network model, and select, based on the first performance information and the second performance information, a candidate partition layer of the different candidate partition layers for partitioning the neural network model into the first sub-neural network model on the first device and the second sub-neural network model on the second device.

Some examples of the method, apparatuses, and non-transitory computer-readable medium described herein may further include operations, features, means, or instructions for selecting, after performing a first iteration of a training session using the candidate partition layer, a second candidate partition layer for partitioning the neural network model and performing a second iteration of the training session using the second candidate partition layer.

Some examples of the method, apparatuses, and non-transitory computer-readable medium described herein may further include operations, features, means, or instructions for obtaining updated first performance information of the first device based on performing a threshold quantity of iterations of the training session and receiving updated second performance information of the second device based on performing the threshold quantity of iterations, where the second candidate partition layer may be selected based on the updated first performance information and the updated second performance information.

In some examples of the method, apparatuses, and non-transitory computer-readable medium described herein, the second candidate partition layer may be selected based on a gradient for updating a weight of the second candidate partition layer being less than a threshold gradient.

In some examples of the method, apparatuses, and non-transitory computer-readable medium described herein, the first performance information and the second performance information each include latency information and power consumption information.

Some examples of the method, apparatuses, and non-transitory computer-readable medium described herein may further include operations, features, means, or instructions for transmitting a request to partition the neural network model to the second device, where the second performance information may be received based on transmitting the request.

In some examples of the method, apparatuses, and non-transitory computer-readable medium described herein, the request may be transmitted based on a processing capability of the first device.

Some examples of the method, apparatuses, and non-transitory computer-readable medium described herein may further include operations, features, means, or instructions for receiving a request to partition the neural network model from the second device, where the first performance information may be obtained based on receiving the request.

Some examples of the method, apparatuses, and non-transitory computer-readable medium described herein may further include operations, features, means, or instructions for transmitting an indication of the candidate partition layer to the second device based on selecting the candidate partition layer.

Some examples of the method, apparatuses, and non-transitory computer-readable medium described herein may further include operations, features, means, or instructions for performing part of a training session iteration using the first sub-neural network model and transmitting an output of the candidate partition layer to the second device based on performing part of the training session iteration.

Some examples of the method, apparatuses, and non-transitory computer-readable medium described herein may further include operations, features, means, or instructions for receiving, from the second device based on transmitting the output, a second output of a second layer of the neural network model that may be adjacent to the candidate partition layer and updating one or more weights of the candidate partition layer based on the second output.

Some examples of the method, apparatuses, and non-transitory computer-readable medium described herein may further include operations, features, means, or instructions for receiving an output of the candidate partition layer from the second device and performing part of a training session iteration using the first sub-neural network model based on the output of the candidate partition layer.

Some examples of the method, apparatuses, and non-transitory computer-readable medium described herein may further include operations, features, means, or instructions for transmitting, to the first device, a second output, of a second layer of the neural network model that may be adjacent to the candidate partition layer, for updating one or more weights of the candidate partition layer.

Some examples of the method, apparatuses, and non-transitory computer-readable medium described herein may further include operations, features, means, or instructions for performing part of a task using the first sub-neural network model, where the first sub-neural network model includes the candidate partition layer and transmitting an output of the candidate partition layer to the second device for use by the second sub-neural network model.

### BRIEF DESCRIPTION OF THE DRAWINGS

FIG. 1 illustrates an example of a wireless communications system that supports neural network model partitioning in accordance with one or more aspects of the present disclosure.

FIG. 2 illustrates an example of a wireless communications system that supports neural network model partitioning in accordance with one or more aspects of the present disclosure.

FIG. 3 illustrates an example of a process flow that supports neural network model partitioning in a wireless communication system in accordance with one or more aspects of the present disclosure.

FIG. 4 illustrates an example of a process flow that supports neural network model partitioning in a wireless communication system in accordance with one or more aspects of the present disclosure.

FIG. 5 illustrates an example of a process flow that supports neural network model partitioning in a wireless communication system in accordance with one or more aspects of the present disclosure.

FIGS. 6 and 7 illustrate block diagrams of devices that support neural network model partitioning in a wireless communication system in accordance with one or more aspects of the present disclosure.

FIG. 8 illustrates a block diagram of a communications manager that supports neural network model partitioning in a wireless communication system in accordance with one or more aspects of the present disclosure.

FIG. 9 illustrates a diagram of a system including a device that supports neural network model partitioning in a wireless communication system in accordance with one or more aspects of the present disclosure.

FIG. 10 illustrates a flowchart showing methods that support neural network model partitioning in a wireless communication system in accordance with one or more aspects of the present disclosure.

### DETAILED DESCRIPTION

In some wireless communication systems, a device may use a neural network model to perform various tasks. For example, a device may use a neural network model to perform estimation of a wireless channel. Before using a neural network model to perform a task, the device may perform a training session to train the neural network model to perform the task. But training and using a neural network model may be challenging for devices with limited resources, such as Internet of Things (IoT) devices and vehicles. For example, training a neural network model may consume excessive power or processing resources at the device, which in turn may negatively impact the performance of the device.

According to the techniques described herein, a first device may partition a neural network model into a first sub-neural network model that is implemented by the first device and a second sub-neural network model that is implemented by a second device. To do so, the first device may select a partition layer for splitting the neural network model that allows the co-implemented neural network to meet desired metrics (e.g., latency metrics, power consumption metrics). For example, the first device may select the partition layer based on performance information (e.g., power consumption information, latency information) for the first device and the second device. In some examples, the partition layer may be dynamically updated (e.g., partway through a training session) based on updated performance information or based on gradients determined during a training session.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to neural network model partitioning in a wireless communication system.

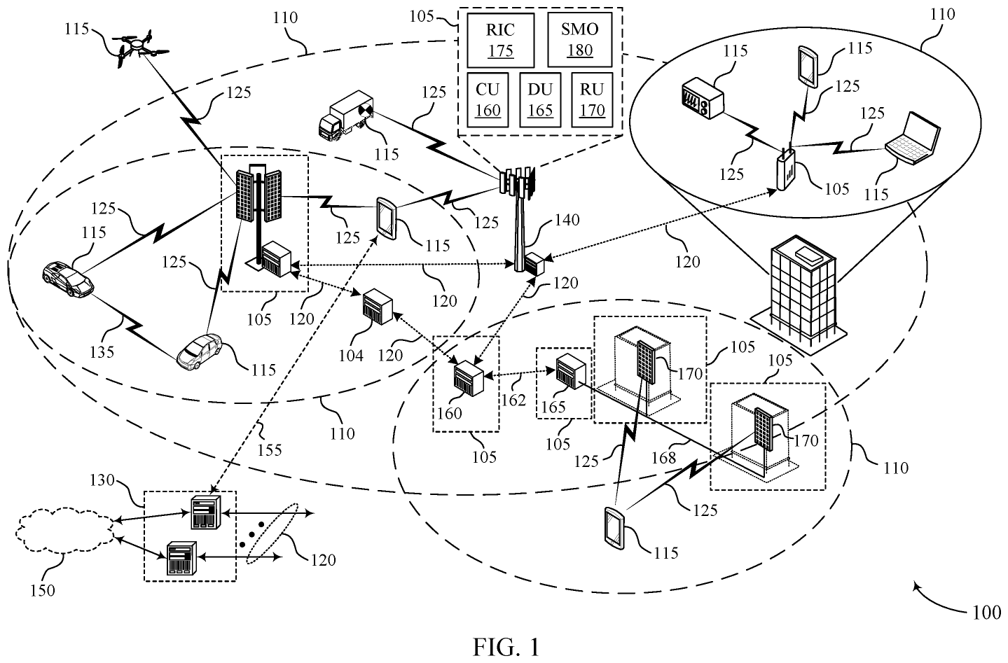

FIG. 1 illustrates an example of a wireless communications system 100 that supports neural network model partitioning in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support neural network model partitioning in a wireless communication system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a device of the wireless communications system 100 may implement a neural network model to perform various tasks for wireless communications or other types of operations. To preserve resources (e.g., power, computational, or processing resources), which may be particularly limited for certain types of devices such as IoT devices, the device may split the neural network model inference and training tasks between itself and another device (e.g., a device with more resources such as a server or network entity 105). For instance, the device may partition the neural network model at a partition layer into two sub-neural network models, one of which is implemented by the device and the other of which is implemented by the other device.

The device may use the techniques described herein to select a partition layer for partitioning the neural network model such that the latency and/or power consumption associated with the neural network model satisfies desired thresholds. For example, the device may use performance information associated with different candidate partition layers to select a partition layer for partitioning the neural network model. To account for changes in the network or the devices, the device may dynamically update the partition layer using a similar technique or based on gradients generated during training or use of the partitioned neural network model.

A neural network (NN) model may also be referred to as neural network algorithm, an artificial intelligence (AI) model, a machine learning (ML) model, or other suitable terminology. Although described with reference to a wireless communications system, the techniques described herein may be implemented in other types of communication systems including wired communications systems.

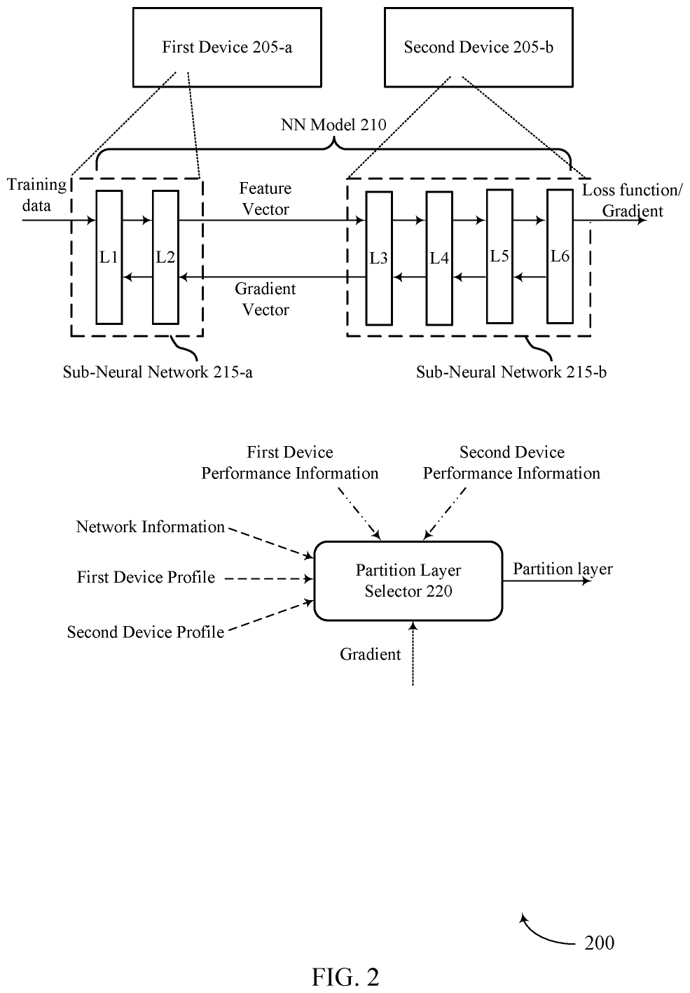

FIG. 2 illustrates an example of a wireless communications system 200 that supports neural network model partitioning in accordance with one or more aspects of the present disclosure. The wireless communications system 200 may implement or be implemented by aspects of the wireless communications system 100, as described with reference to FIG. 1. For example, the wireless communications system 200 may include devices 205, which may be examples of UEs or network entities as described herein, including with reference to FIG. 1. The devices 205 may alternatively be other types of devices, including devices capable of wired communications. In some examples, the first device 205-a may be an example of a resource-limited device (e.g., a UE, an IoT device) and the second device may be an example of a resource-abundant device (e.g., a server, a network entity).

The devices 205 may implement a partitioned neural network model such as NN model 210, which may include multiple layers (e.g., layer L1 through layer L6). For example, the first device 205-a may implement a portion of the NN model 210, referred to as sub-neural network model 215-a, that includes layers L1 and L2. And the second device 205-b may implement another portion of the NN model 210, referred to as sub-neural network model 215-b, that includes layers L3, L4, L5, and L6.

To train the NN model 210, training data may be input into the first layer of the NN model 210 (e.g., L1) and passed forward (e.g., internally) through the layers of the sub-neural network model 215-a. The layers may operate on the training data and generate outputs (e.g., features, feature vectors) for use by adjacent up-stream layers. At the partition layer (e.g., layer L2), the first device 205-a may transmit the output (e.g., a feature vector) generated by the sub-neural network model 215-a (which may be outputted by the partition layer L2) to the second device 205-b. The second device 205-b may continue the forward pass of the received feature vector though the sub-neural network model 215-b. Upon finishing the forward pass, the second device 205-b may calculate a predetermined loss function and one or more gradients (e.g., gradient vectors) and pass the gradient(s) backward through the layers of the sub-neural network model 215-b. So, after the forward pass at the last layer, a loss may be calculated according to a predetermined loss function (e.g., mean squared error) and the first gradient(s) may be the derivative(s) of this loss function. The backward pass through NN model 210 may involve calculation of derivatives of the NN model 210 moving from the final layer (e.g., layer L6) to the first layer (e.g., layer L1). The derivatives of each layer may be multiplied down the NN model 210 to compute subsequent derivatives.

During the backward pass through sub-neural network model 215-b, the second device 205-b may update the weights of the layers of sub-neural network model 215-b based on the gradients. At the layer (e.g., layer L3) adjacent to the partition layer, the second device 205-b may transmit the output (e.g., a gradient vector) generated by the sub-neural network model 215-b (which may be outputted by layer L3) to the first device 205-a. A first layer is adjacent to a second layer if the layers are configured to directly exchange outputs (e.g., without use of intervening layers).

The first device 205-a may continue the backward pass of the received gradient vector though the sub-neural network model 215-a. During the backward pass through sub-neural network model 215-a, the first device 205-a may update the weights of the layers of sub-neural network model 215-a based on the gradients.

Thus, an iteration of a training session for the NN model 210 may be co-implemented by the first device 205-a and the second device 205-b. A training session may involve multiple iterations that are performed on different sets (e.g., batches) of training data. Upon completion of a training session, the NN model 210 may be used by the first device 205-a and the second device 205-b to perform various inference tasks, such as channel estimation.

The latency and power consumption associated with training and use of the NN model 210 may vary based on the layer selected for partitioning the NN model 210. For example, use of layer L2 as the partition layer may be associated with a first latency and a first amount of power consumption whereas use of a different layer (e.g., layer L3) as the partition layer may be associated with a second latency and a second amount of power consumption. One of the device 205 may implement the partition layer-selection techniques described herein to reduce the latency and/or power consumption associated with training and using the NN model 210.

For example, a device 205 may include a partition layer selector 220 that selects a partition layer for the NN model 210. The partition layer selector 220 may select the partition layer for the NN model 210 based on various parameters and metrics.

In some examples, the partition layer selector 220 may select the partition layer based on metrics of the communications network (referred to as “network information”) and metrics of the devices 205 (referred to as “first device profile” and “second device profile”). The network information may include uplink data rates and throughput for the network, downlink data rates and throughput for the network, channel information, or any combination thereof. The profile for a device may include a training profile for the device, a computation profile for the device, a communication profile for the device, or any combination thereof. The training profile for a device may indicate any or all of: the computational burden, the latency, the power consumption, and the amount of transferred data for the forward pass and/or the backward pass through the sub-neural network implemented by that device. The computation profile for a device may indicate any or all of: the clock rate, floating-point operations per second (FLOPs), and power consumption of that device. The communication profile for a device may include the power consumption associated with transmitting training information (e.g., feature vectors, gradient vectors), receiving training information, or both.

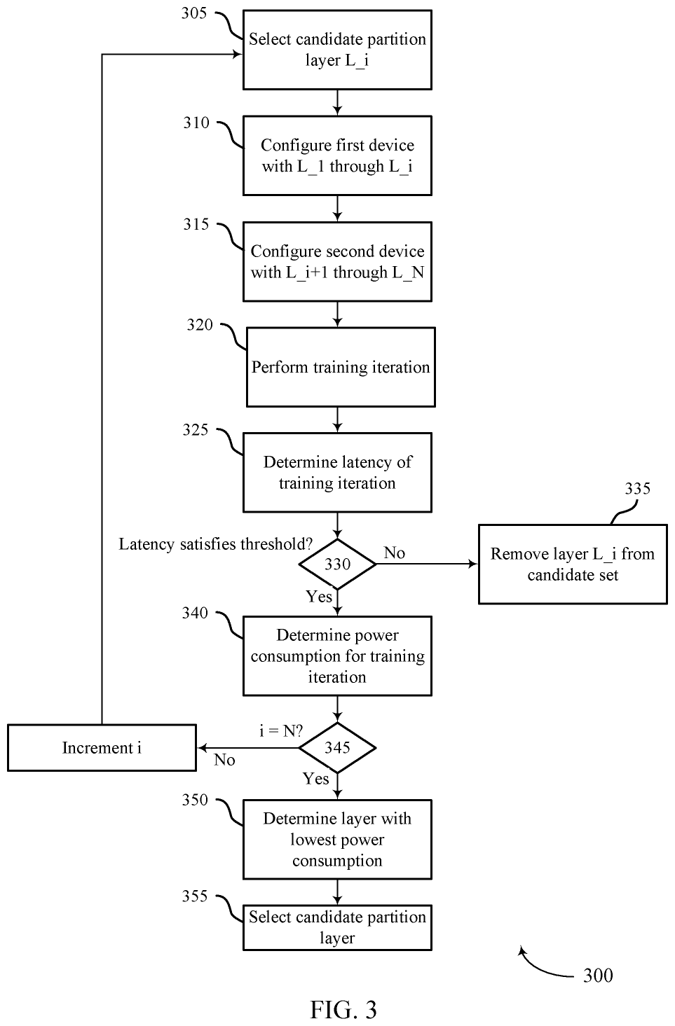

In some examples, the partition layer selector 220 may select the partition layer based on performance information for the devices 205. For instance, the partition layer selector 220 may select the partition layer based on first performance information of the first device 205-a and based on second performance information of the second device 205-b. The first performance information of the first device 205-a may include latency information and power consumption information, for the first device 205-a, that is associated with different candidate partition layers for partitioning the NN model 210. The second performance information of the second device 205-b may include latency information and power consumption information, for the second device 205-b, that is associated with different candidate partition layers for partitioning the NN model 210. FIG. 3 provides additional details for selection of the partition layer based on performance information.

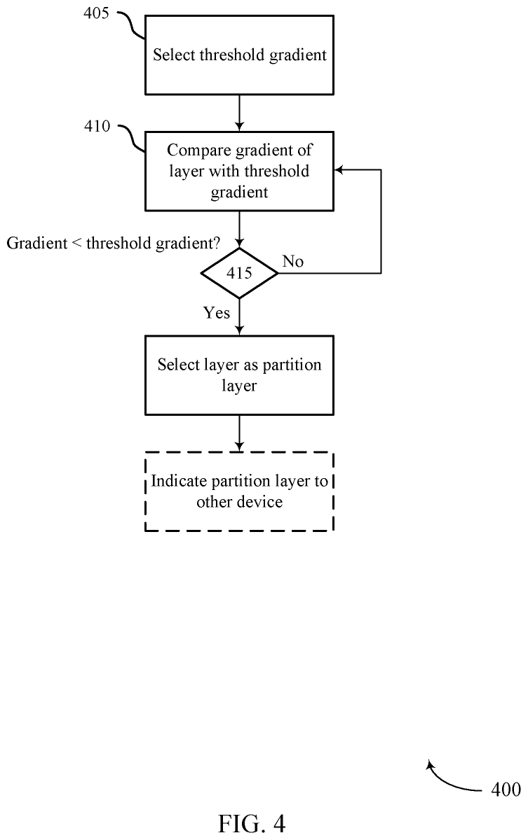

In some examples, the partition layer selector 220 may select the partition layer based on gradients generated by the NN model 210. For instance, the partition layer selector 220 may select the partition layer based on the partition layer being associated with a gradient that is less than a threshold gradient. During training, the gradients of the NN model 210 may decrease as they are passed backwards through the NN model 210. Since small gradients are associated with small weight adjustments that negligibly affect associated layers, the partition layer selector 220 may select a partition layer that is associated with a sufficiently small gradient (e.g., a gradient that is less than or equal to a threshold gradient). FIG. 4 provides additional details for selection of the partition layer based on gradients.

Thus, the devices 205 may train and co-implement a neural network model, which may be partitioned at a partition layer selected by the partition layer selector 220. In some examples, the devices 205 may train and use a neural network model to perform an operation for wireless communications. For examples, the devices 205 may train and use the NN model 210 to predict channel characteristics of communication beams for the first device 205-a based on measured channel characteristics of other communication beams. The first device 205-a may then report beam characteristic predictions to a network entity to facilitate wireless communications with the network entity. Because the resources used to train and implement such a model may be more than the first device 205-a can support, the NN model 210 may be split between the devices 205. For example, part of the NN model 210 may be offloaded from the first device 205-a to the second device 205-b as described herein, which may allow the first device 205-a to realize the benefits of the NN model 210 without bearing the full resource cost of the NN model 210.

FIG. 3 illustrates an example of a process flow 300 that supports neural network model partitioning in a wireless communication system in accordance with one or more aspects of the present disclosure. The process flow 300 may be implemented by aspects of the wireless communications systems 100 or 200 as described with reference to FIGS. 1 and 2. For example, the process flow 300 may be implemented by a first device 205 as described with reference to FIG. 2. The first device may implement the process flow 300 to select a partition layer for a neural network model based on performance information associated with the first device and a second device between which the neural network model is to be partitioned. The neural network model may include N layers (e.g., layer L_1 through layer L_N), each of which may be initially included in a set of candidate partition layers for the neural network model.

The process flow 300 may be used by the first device to select a partition layer that uses the least amount of power while satisfying a latency metric. However, process flows similar to the process flow 300 may be implemented to select a partition layer that satisfies other metrics.

At 305, the first device may select a candidate partition layer L_i for an iteration of a training session using a set of data with size S. At 310, the first device may configure a first sub-neural network model that includes layers L_1 through L_i (e.g., the candidate partition layer) for the training session. At 315, the first device may configure the second device with a second sub-neural network model that includes layers L_i+1 (e.g., the layer adjacent to the candidate partition layer) through L_N for the training session.

At 320, the first device and the second device may perform an iteration of the training session using the set of data. For example, the first device may perform part of the training session iteration using the first sub-neural network that includes the candidate partition layer and the second device may perform part of the training session iteration using the second sub-neural network.

At 325, the first device may determine the latency of the training session iteration. The first device may determine the latency of the training session iteration based on a timer that the first device starts at the beginning of the iteration and stops at the end of the iteration. Alternatively, the first device may determine the latency based on latency information calculated by the first device and latency information received from the second device.

At 330, the first device may determine whether the latency of the training iteration for candidate partition layer L_i satisfies (e.g., is less than or equal to) a threshold latency. If the latency does not satisfy the threshold latency, the first device may, at 335, remove the candidate partition layer L_i from the set of candidate partition layers. If the latency satisfies (e.g., is less than) the latency threshold, the first device maintain the partition layer L_i in the set of candidate partition layers and proceed to 340. Although described with reference to removing partition layers from a set of candidate partition layers, the process flow 300 may alternatively be used to build a set of candidate partition layers by adding to the set layers that satisfy various metrics.

At 340, the first device may determine the power consumption associated with the training session iteration. The first device may determine the power consumption based on power consumption information calculated by the first device and power consumption information received from the second device. For example, the power consumption associated with the training session iteration may be the sum of the power consumed by the first device to perform part of the iteration (including the power consumed to communicate with the second device) and the power consumed by the second device to perform another part of the iteration (including the power consumed to communicate with the first device).

At 345, the first device may determine whether the candidate partition layer L_i is the last layer in the set of candidate partition layers (e.g., the first device may determine whether the candidate partition layer L_i is layer L_N). If the candidate partition layer L_i is the not the last layer, the first device may increment i (e.g., select the next layer for evaluation) and proceed to 305. If the candidate partition layer L_i is the last layer, the first device may, at 350, determine the candidate partition layer in the set of candidate partition layers that has the lowest power. At 355, the first device may select as the partition layer the candidate partition layer (from the set of candidate partition layers that satisfies the latency metric) with the lower power consumption.

Thus, the first device may select a partition layer based on performance information (e.g., latency information, power consumption information) for the first device and the second device. The process flow 300 may be used by the first device to select an initial partition layer or to update the partition layer (e.g., partway through a training session, during a subsequent training session).

FIG. 4 illustrates an example of a process flow 400 that supports neural network model partitioning in a wireless communication system in accordance with one or more aspects of the present disclosure. The process flow 400 may be implemented by aspects of the wireless communications systems 100 or 200 as described with reference to FIGS. 1 and 2. For example, the process flow 400 may be implemented by a device 205 as described with reference to FIG. 2. The device may implement the process flow 400 to select a partition layer for a neural network model based on gradients generated by the neural network model. The neural network model may include N layers (e.g., layer L_1 through layer L_N).

At 405, the device may select a threshold gradient for selecting a partition layer for the neural network model. At 410, the device may compare the gradient generated (and outputted) by a layer of the neural network model (e.g., during a backward propagation) with the threshold gradient. At 415, the device may determine whether the gradient generated by the layer is less than or equal to the threshold gradient. If the gradient generated by the layer is greater than the threshold gradient, the device may move to the next layer and perform the operations at 410.

If the gradient generated by the layer is less than or equal to the threshold gradient, the device may proceed to 420 and select the associated layer as the partition layer for the neural network model. At 425, the device may indicate the partition layer to the device between which the neural network model is (or will be) partitioned. If the other device is the first device 205-a from FIG. 2, the first device may skip (e.g., refrain from performing) the rest of the backward propagation that occur after the partition layer or may set the learning rate to zero.

Thus, the device may select a partition layer based on gradients generated by a neural network mode. The process flow 400 may be used by a device to select an initial partition layer or to update the partition layer (e.g., partway through a training session, during a subsequent training session).

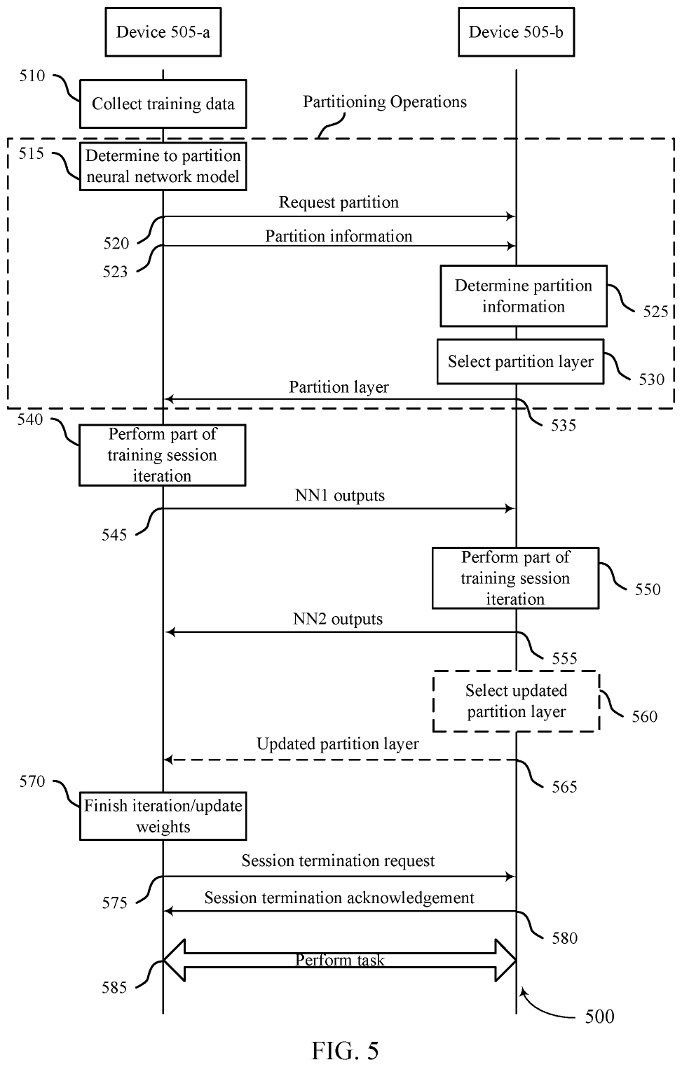

FIG. 5 illustrates an example of a process flow 500 that supports neural network model partitioning in a wireless communication system in accordance with one or more aspects of the present disclosure. The process flow 500 may be implemented by aspects of the wireless communications systems 100 or 200 as described with reference to FIGS. 1 and 2. For example, the process flow 500 may be implemented by a device 505-a and a device 505-b, which maybe examples of the devices 205 as described with reference to FIG. 2. The devices 505 may implement the process flow 500 to partition a neural network model for training and use.

Although described with reference to certain devices performing certain operations, performance of the operations of the process flow 500 are not limited to the illustrated devices. For example, operations shown being performed by the device 505-a may be performed by the device 505-b, and vice versa.

At 510, the device 505-a may collect training data (e.g., via sensors) for training the neural network model. At 515, the device 505-a may determine to partition the neural network model (e.g., for training). The device 505-a may determine to partition the neural network model based on information such as the size (e.g., amount) of the training data, the status of processing resources at the device 505-a, the processing capability of the device 505-a, the training profile for the device 505-a, computation profile for the device 505-a, the communication profile for the device 505-a, the training profile for the device 505-b, computation profile for the device 505-b, the communication profile for the device 505-b, or any combination thereof, among other metrics. In some examples, the device 505-a may determine to partition the neural network based on the available processing resources or power resources at the device 505-a failing to satisfy a threshold.

At 520, the device 505-a may transmit to the device 505-b a request to partition the neural network model. The device 505-a may transmit the request based on determining to partition the neural network model.

At 523, the device 505-a may transmit to the device 505-b partition information for determining the partition layer for the neural network model. For example, the partition information may include information related to the training data (e.g., modality, such as image or time series, size specifications, quantity of training samples).

The partition information may additionally or alternatively include information related to the neural network model (e.g., the task type, such as regression or classification, the status of the neural network model, the architecture of the neural network model, candidate training parameters for the neural network model, such as the available learning rate, loss function and training performance metrics, such as classification accuracy, current performance metrics, such as accuracy and loss). The partition information may additionally or alternatively include information related to the processing capability of the device 505-a (e.g., process type, such as CPU or GPU, clock speed, FLOPs per second). The partition information may additionally or alternatively include profile information or performance information for the device 505-a.

At 525, the device 505-b may determine partition information for the device 505-b. In some examples, the device 505-b may determine the partition information based on (e.g., in response to) the partition request received at 520. The partition information may be similar to the partition information described with reference to 520.

At 530, the device 505-b may select a partition layer for partitioning the neural network model. The device 505-b may select the partition layer based on the partition information for the device 505-a and the partition information for the device 505-b, among other information. For example, the device 505-b may select the partition layer based on network information (e.g., uplink data rates and throughput for the network, downlink data rates and throughput for the network, channel information), profile information for the device 505-a, performance information for the device 505-a, profile information for the device 505-b, performance information for the device 505-b, or any combination thereof, among other types of information. In some examples, the device 505-b may implement aspects of the process flow 300 or the process flow 400 to select the partition layer.

At 535, the device 505-b may transmit an indication of the partition layer to the device 505-a. The device 505-b may also transmit information such as the size of the training data and the training parameters (e.g., learning rate) for training at the device 505-a.

In some examples, the device 505-a may be the device that selects the partition layer. In such examples, the device 505-a may transmit a request for partition information for the device 505-b and, in response to receiving the partition information, may select the partition layer. Further, the device 505-a may transmit an indication of the partition layer to the device 505-b. For example, at 523, the device 505-b may transmit to the device 505-a partition information for determining the partition layer for the neural network model. The partition information may include information related to the processing capability of the device 505-b (e.g., process type, such as CPU or GPU, clock speed, FLOPs per second). The partition information may additionally or alternatively include profile information or performance information for the device 505-b.

At 525, the device 505-a may determine partition information for the device 505-a. In some examples, the device 505-a may determine the partition information based on (e.g., in response to) the partition information received at 523. The partition information may be similar to the partition information described with reference to 520.

At 530, the device 505-a (instead of the device 505-b) may select a partition layer for partitioning the neural network model. The device 505-a may select the partition layer based on the partition information for the device 505-a and the partition information for the device 505-b, among other information. For example, the device 505-a may select the partition layer based on network information (e.g., uplink data rates and throughput for the network, downlink data rates and throughput for the network, channel information), profile information for the device 505-a, performance information for the device 505-a, profile information for the device 505-b, performance information for the device 505-b, or any combination thereof, among other types of information. In some examples, the device 505-b may implement aspects of the process flow 300 or the process flow 400 to select the partition layer.

At 535, the device 505-a may transmit an indication of the partition layer to the device 505-b. The device 505-a may also transmit information such as the size of the training data and the training parameters (e.g., learning rate) for training at the device 505-b.

Thus, the partitioning operations between 515 and 535 may performed by the devices as illustrated or may be performed by the devices in a different manner than illustrated.

At 540, the device 505-b may perform part of a training session iteration using a first sub-neural network model that is based on the partition layer. At 545, the device 505-a may transmit to the device 505-b outputs generated by the first sub-neural network model (denoted NN1). For example, the device 505-a may transmit one or more feature vectors generated by the first sub-neural network. The one or more feature vectors may include a feature vector outputted by the partition layer. The device 505-a may additionally or alternatively transmit one or more labels associated with the feature vectors (e.g., for supervised learning tasks).

At 550, the device 505-b may perform, using a second sub-neural network model that includes a layer adjacent to the partition layer, part of the training session iteration based on the outputs received from the device 505-a. As part of the training session iteration, the device 505-b may generate gradients and update the weights of layers based on the gradients.

At 555, the device 505-b may transmit to the device 505-a outputs generated by the second sub-neural network model (denoted NN2). For example, the device 505-b may transmit one or more gradient vectors generated by the second sub-neural network. The one or more gradient vectors may include a gradient vector outputted by the layer adjacent to the partition layer. In some examples, the device 505-b may also transmit updated model information such as updated (e.g., most recent) classification accuracy on validation data (which may be pre-loaded onto the second device 505-b) for a classification task, mean squared error (MSE) on the validation data (e.g., for a regression task), one or more loss functions associated with the neural network model, summary statistics of training weights updated for certain layers, or any combination thereof, among other model information.

At 560, the device 505-b may select an updated partition layer. The device 505-b may select the updated partition layer based on the gradients output by the second sub-neural network model. For example, the device 505-b may select (as the updated partition layer) a layer of the second sub-neural network model that is associated with a gradient that is less than or equal to a threshold gradient (e.g., as described with reference to FIG. 4). At 565, the device 505-b may transmit to the device 505-a an indication of the updated partition layer. The device 505-a and the device 505-b may update the layers of the sub-neural network models based on the updated partition layer. In some examples, the operations at 560 and 565 may be performed by the device 505-a.

At 570, the device 505-a may finish the iteration of the training session. In some examples, finishing the iteration of the training session may include updating the weights of the layers in the first sub-neural network model based on gradient information receive from the device 505-b. Thus, the device 505-a and the device 505-b may collectively perform an iteration of a training session for the neural network model that is split between the device 505-a and the device 505-b.

The device 505-a and the device 505-b may repeat the operations of the process flow 500 to perform multiple iterations of the training session. In some examples, the devices 505 may selectively perform the partitioning operations (e.g., 515 through 530). For instance, the devices 505 may perform the partitioning operations every nth iteration so that the partition layer can be updated to account for changes in the device or the network. Thus, on the nth iteration, the device 505-a may transmit updated partition information to the device 505-b and the device 505-b may determine updated partition information for the device 505-b, both of which may be used by the device 505-b to select an updated partition layer.

At 575, the device 505-a may transmit to the device 505-b a request to terminate the training session. The device 505-a may transmit the request based on performing a threshold quantity of training session iterations with the device 505-b. At 580, the device 505-b may transmit to the device 505-a a message acknowledging the termination of the training session. After training the neural network model, the devices 505 may use the neural network model to perform one or more inference tasks. For example, at 585, the devices 505 may perform a task (e.g., channel estimation) using the sub-neural network models trained via the process flow 500. In some examples, the operations at 585 may include the first device 505-a performing part of the task using the first sub-neural network and transmitting an output (e.g., feature vector) of the partition layer to the second device 505-b for use by the second sub-neural network.

Thus, the devices 505 may implement the process flow 500 to partition a neural network model for training and use.

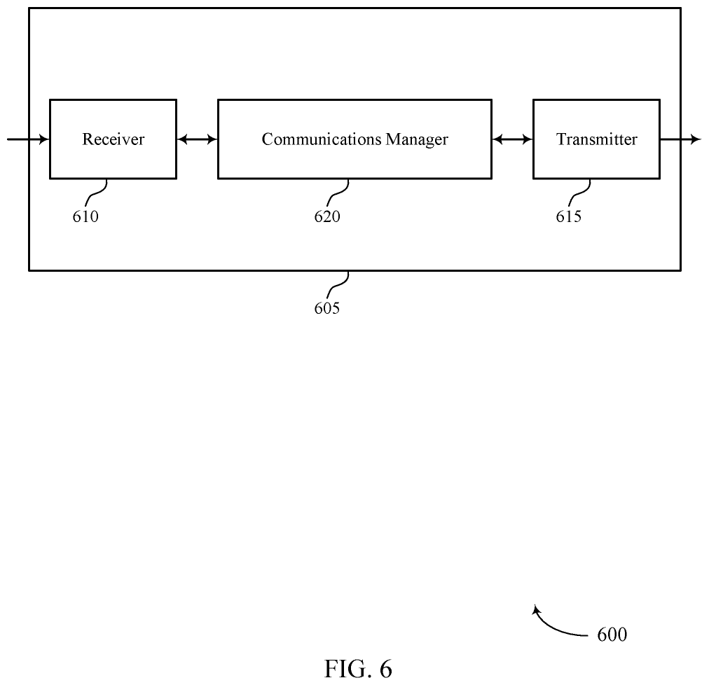

FIG. 6 illustrates a block diagram 600 of a device 605 that supports neural network model partitioning in a wireless communication system in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to neural network model partitioning in a wireless communication system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to neural network model partitioning in a wireless communication system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of neural network model partitioning in a wireless communication system as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first device in accordance with examples as disclosed herein. For example, the communications manager 620 may be configured as or otherwise support a means for obtaining first performance information of the first device associated with different candidate partition layers for partitioning a neural network model into a first sub-neural network model on the first device and a second sub-neural network model on a second device. The communications manager 620 may be configured as or otherwise support a means for receiving second performance information of the second device associated with the different candidate partition layers for partitioning the neural network model. The communications manager 620 may be configured as or otherwise support a means for selecting, based on the first performance information and the second performance information, a candidate partition layer of the different candidate partition layers for partitioning the neural network model into the first sub-neural network model on the first device and the second sub-neural network model on the second device.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and reduced power consumption.

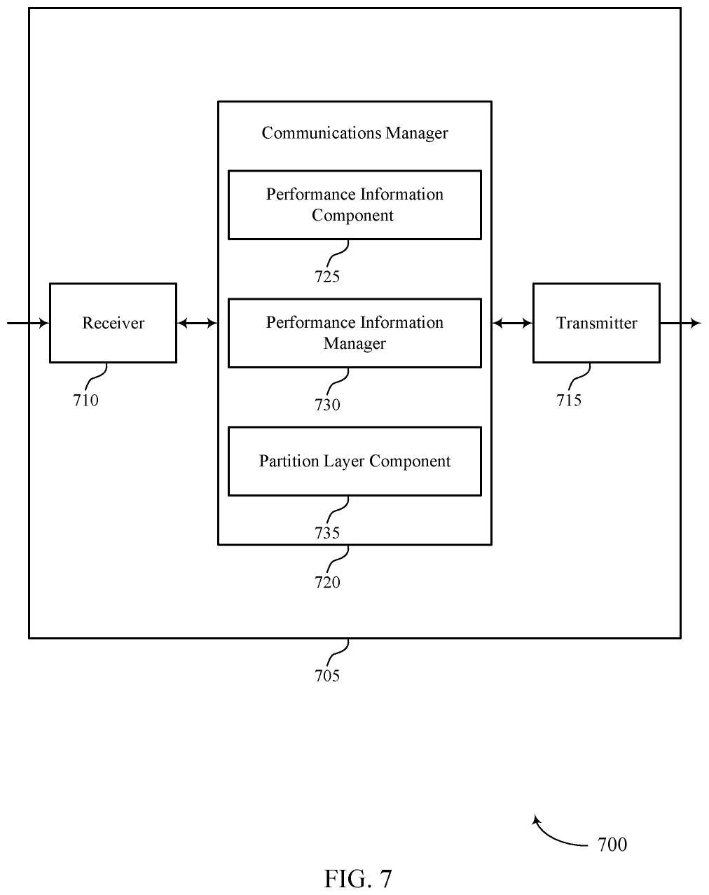

FIG. 7 illustrates a block diagram 700 of a device 705 that supports neural network model partitioning in a wireless communication system in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to neural network model partitioning in a wireless communication system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to neural network model partitioning in a wireless communication system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of neural network model partitioning in a wireless communication system as described herein. For example, the communications manager 720 may include a performance information component 725, a performance information manager 730, a partition layer component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first device in accordance with examples as disclosed herein. The performance information component 725 may be configured as or otherwise support a means for obtaining first performance information of the first device. The first performance information may be associated with different candidate partition layers for partitioning a neural network model into a first sub-neural network model on the first device and a second sub-neural network model on a second device. The performance information manager 730 may be configured as or otherwise support a means for receiving second performance information of the second device. The second performance indication may be associated with the different candidate partition layers for partitioning the neural network model. The partition layer component 735 may be configured as or otherwise support a means for selecting, based on the first performance information and the second performance information, a candidate partition layer of the different candidate partition layers for partitioning the neural network model into the first sub-neural network model on the first device and the second sub-neural network model on the second device.

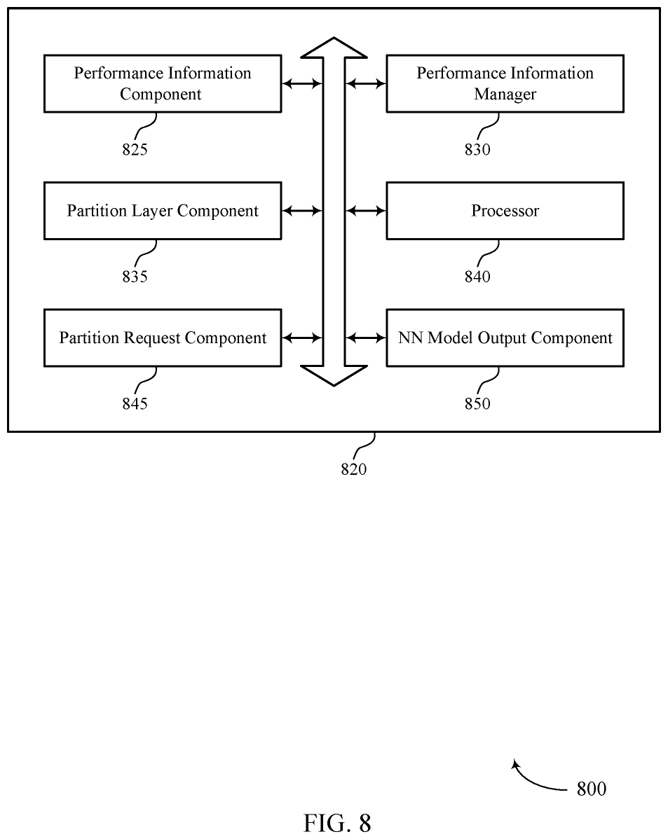

FIG. 8 illustrates a block diagram 800 of a communications manager 820 that supports neural network model partitioning in a wireless communication system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of neural network model partitioning in a wireless communication system as described herein. For example, the communications manager 820 may include a performance information component 825, a performance information manager 830, a partition layer component 835, a processor 840, a partition request component 845, an NN model output component 850, or any combination thereof. Each of these components may communicate, directly or indirectly, with one another (e.g., via one or more buses).

The communications manager 820 may support wireless communication at a first device in accordance with examples as disclosed herein. The performance information component 825 may be configured as or otherwise support a means for obtaining first performance information of the first device. The first performance information may be associated with different candidate partition layers for partitioning a neural network model into a first sub-neural network model on the first device and a second sub-neural network model on a second device. The performance information manager 830 may be configured as or otherwise support a means for receiving second performance information of the second device. The second performance information may be associated with the different candidate partition layers for partitioning the neural network model. The partition layer component 835 may be configured as or otherwise support a means for selecting, based on the first performance information and the second performance information, a candidate partition layer of the different candidate partition layers for partitioning the neural network model into the first sub-neural network model on the first device and the second sub-neural network model on the second device.

In some examples, the partition layer component 835 may be configured as or otherwise support a means for selecting, after performing a first iteration of a training session using the candidate partition layer, a second candidate partition layer for partitioning the neural network model. In some examples, the processor 840 may be configured as or otherwise support a means for performing a second iteration of the training session using the second candidate partition layer.

In some examples, the performance information component 825 may be configured as or otherwise support a means for obtaining updated first performance information of the first device based on performing a threshold quantity of iterations of the training session. In some examples, the performance information component 825 may be configured as or otherwise support a means for receiving updated second performance information of the second device based on performing the threshold quantity of iterations, where the second candidate partition layer is selected based on the updated first performance information and the updated second performance information.

In some examples, the second candidate partition layer is selected based on a gradient for updating a weight of the second candidate partition layer being less than a threshold gradient.

In some examples, the first performance information and the second performance information each include latency information and power consumption information.

In some examples, the partition request component 845 may be configured as or otherwise support a means for transmitting a request to partition the neural network model to the second device, where the second performance information is received based on transmitting the request. In some examples, the request is transmitted based on a processing capability of the first device.

In some examples, the partition request component 845 may be configured as or otherwise support a means for receiving a request to partition the neural network model from the second device, where the first performance information is obtained based on receiving the request.

In some examples, the partition request component 845 may be configured as or otherwise support a means for transmitting an indication of the candidate partition layer to the second device based on selecting the candidate partition layer.

In some examples, the processor 840 may be configured as or otherwise support a means for performing part of a training session iteration using the first sub-neural network model. In some examples, the NN model output component 850 may be configured as or otherwise support a means for transmitting an output of the candidate partition layer to the second device based on performing part of the training session iteration.

In some examples, the NN model output component 850 may be configured as or otherwise support a means for receiving, from the second device based on transmitting the output, a second output of a second layer of the neural network model that is adjacent to the candidate partition layer. In some examples, the processor 840 may be configured as or otherwise support a means for updating one or more weights of the candidate partition layer based on the second output.

In some examples, the NN model output component 850 may be configured as or otherwise support a means for receiving an output of the candidate partition layer from the second device. In some examples, the processor 840 may be configured as or otherwise support a means for performing part of a training session iteration using the first sub-neural network model based on the output of the candidate partition layer.

In some examples, the NN model output component 850 may be configured as or otherwise support a means for transmitting, to the second device, a second output, of a second layer of the neural network model that is adjacent to the candidate partition layer, for updating one or more weights of the candidate partition layer.

In some examples, the processor 840 may be configured as or otherwise support a means for performing part of a task using the first sub-neural network model, where the first sub-neural network model includes the candidate partition layer. In some examples, the NN model output component 850 may be configured as or otherwise support a means for transmitting an output of the candidate partition layer to the second device for use by the second sub-neural network model.

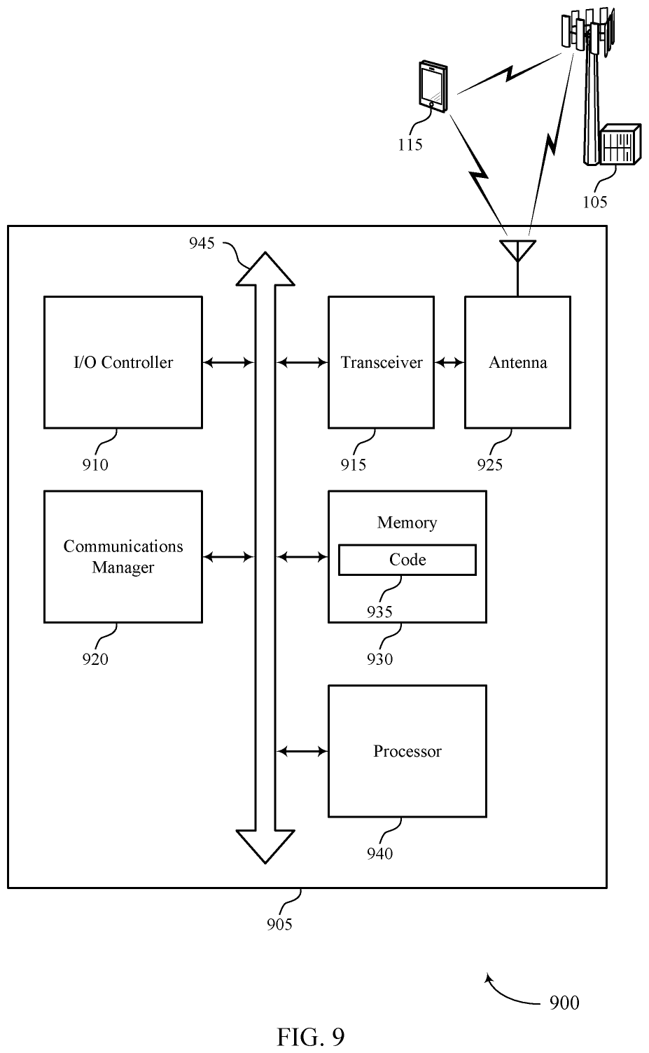

FIG. 9 illustrates a diagram of a system 900 including a device 905 that supports neural network model partitioning in a wireless communication system in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting neural network model partitioning in a wireless communication system). For example, the device 905 or a component of the device 905 may include a processor 940 and memory 930 coupled with or to the processor 940, the processor 940 and memory 930 configured to perform various functions described herein.

The communications manager 920 may support wireless communication at a first device in accordance with examples as disclosed herein. For example, the communications manager 920 may be configured as or otherwise support a means for obtaining first performance information of the first device. The first performance information may be associated with different candidate partition layers for partitioning a neural network model into a first sub-neural network model on the first device and a second sub-neural network model on a second device. The communications manager 920 may be configured as or otherwise support a means for receiving second performance information of the second device. The second performance information may be associated with the different candidate partition layers for partitioning the neural network model. The communications manager 920 may be configured as or otherwise support a means for selecting, based on the first performance information and the second performance information, a candidate partition layer of the different candidate partition layers for partitioning the neural network model into the first sub-neural network model on the first device and the second sub-neural network model on the second device.

By including or configuring the communications manager 920 in accordance with examples as described herein, the device 905 may support techniques for improved user experience related to reduced processing and reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of neural network model partitioning in a wireless communication system as described herein, or the processor 940 and the memory 930 may be otherwise configured to perform or support such operations.

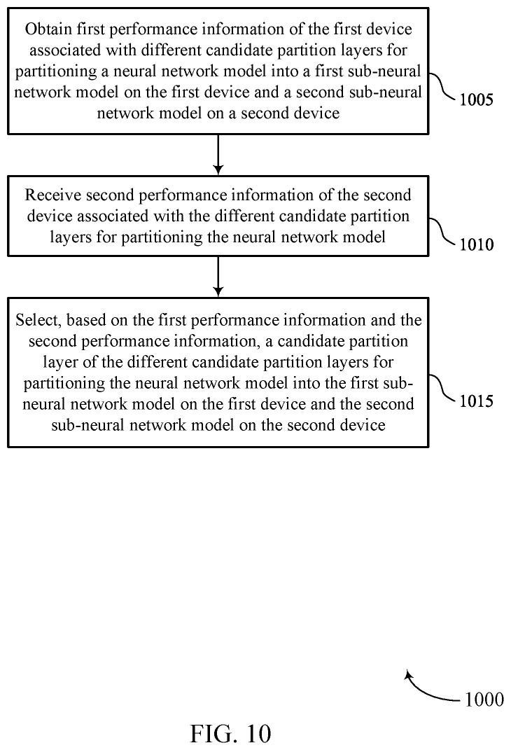

FIG. 10 illustrates a flowchart showing a method 1000 that supports neural network model partitioning in a wireless communication system in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include obtaining first performance information of the first device associated with different candidate partition layers for partitioning a neural network model into a first sub-neural network model on the first device and a second sub-neural network model on a second device. The operations of 1005 may be performed in accordance with examples as disclosed herein. In some examples, aspects of the operations of 1005 may be performed by a performance information component 825 as described with reference to FIG. 8.

At 1010, the method may include receiving second performance information of the second device associated with the different candidate partition layers for partitioning the neural network model. The operations of 1010 may be performed in accordance with examples as disclosed herein. In some examples, aspects of the operations of 1010 may be performed by a performance information manager 830 as described with reference to FIG. 8.

At 1015, the method may include selecting, based on the first performance information and the second performance information, a candidate partition layer of the different candidate partition layers for partitioning the neural network model into the first sub-neural network model on the first device and the second sub-neural network model on the second device. The operations of 1015 may be performed in accordance with examples as disclosed herein. In some examples, aspects of the operations of 1015 may be performed by a partition layer component 835 as described with reference to FIG. 8.

The following provides an overview of aspects of the present disclosure:

Aspect 1: A method for wireless communication at a first device, comprising: obtaining first performance information of the first device associated with different candidate partition layers for partitioning a neural network model into a first sub-neural network model on the first device and a second sub-neural network model on a second device; receiving second performance information of the second device associated with the different candidate partition layers for partitioning the neural network model; and selecting, based at least in part on the first performance information and the second performance information, a candidate partition layer of the different candidate partition layers for partitioning the neural network model into the first sub-neural network model on the first device and the second sub-neural network model on the second device.

Aspect 2: The method of aspect 1, further comprising: selecting, after performing a first iteration of a training session using the candidate partition layer, a second candidate partition layer for partitioning the neural network model; and performing a second iteration of the training session using the second candidate partition layer.

Aspect 3: The method of aspect 2, further comprising: obtaining updated first performance information of the first device based at least in part on performing a threshold quantity of iterations of the training session; and receiving updated second performance information of the second device based at least in part on performing the threshold quantity of iterations, wherein the second candidate partition layer is selected based at least in part on the updated first performance information and the updated second performance information.

Aspect 4: The method of aspect 2, wherein the second candidate partition layer is selected based at least in part on a gradient for updating a weight of the second candidate partition layer being less than a threshold gradient.

Aspect 5: The method of any of aspects 1 through 4, wherein the first performance information and the second performance information each comprise latency information and power consumption information.

Aspect 6: The method of any of aspects 1 through 5, further comprising: transmitting a request to partition the neural network model to the second device, wherein the second performance information is received based at least in part on transmitting the request.

Aspect 7: The method of aspect 6, wherein the request is transmitted based at least in part on a processing capability of the first device.

Aspect 8: The method of any of aspects 1 through 5, further comprising: receiving a request to partition the neural network model from the second device, wherein the first performance information is obtained based at least in part on receiving the request.

Aspect 9: The method of aspect 8, further comprising: transmitting an indication of the candidate partition layer to the second device based at least in part on selecting the candidate partition layer.

Aspect 10: The method of any of aspects 1 through 9, further comprising: performing part of a training session iteration using the first sub-neural network model; and transmitting an output of the candidate partition layer to the second device based at least in part on performing part of the training session iteration.

Aspect 11: The method of aspect 10, further comprising: receiving, from the second device based at least in part on transmitting the output, a second output of a second layer of the neural network model that is adjacent to the candidate partition layer; and updating one or more weights of the candidate partition layer based at least in part on the second output.

Aspect 12: The method of any of aspects 1 through 9, further comprising: receiving an output of the candidate partition layer from the second device; and performing part of a training session iteration using the first sub-neural network model based at least in part on the output of the candidate partition layer.

Aspect 13: The method of aspect 12, further comprising: transmitting, to the first device, a second output, of a second layer of the neural network model that is adjacent to the candidate partition layer, for updating one or more weights of the candidate partition layer.

Aspect 14: The method of any of aspects 1 through 13, further comprising: performing part of a task using the first sub-neural network model, wherein the first sub-neural network model includes the candidate partition layer; and transmitting an output of the candidate partition layer to the second device for use by the second sub-neural network model.

Aspect 15: An apparatus for wireless communication at a first device, comprising a processor; memory coupled with the processor; and instructions stored in the memory and executable by the processor to cause the apparatus to perform a method of any of aspects 1 through 14.

Aspect 16: An apparatus for wireless communication at a first device, comprising at least one means for performing a method of any of aspects 1 through 14.

Aspect 17: A non-transitory computer-readable medium storing code for wireless communication at a first device, the code comprising instructions executable by a processor to perform a method of any of aspects 1 through 14

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first device for wireless communication, comprising:
a processor;
memory coupled with the processor; and
instructions stored in the memory and executable by the processor to cause the first device to:
obtain first performance information of the first device associated with different candidate partition layers for partitioning a neural network model into a first sub-neural network model on the first device and a second sub-neural network model on a second device;
receive second performance information of the second device associated with the different candidate partition layers for partitioning the neural network model; and
select, based at least in part on the first performance information and the second performance information, a candidate partition layer of the different candidate partition layers for partitioning the neural network model into the first sub-neural network model on the first device and the second sub-neural network model on the second device.

2. The first device of claim 1, wherein the instructions are further executable by the processor to cause the first device to:
select, after performing a first iteration of a training session using the candidate partition layer, a second candidate partition layer for partitioning the neural network model; and
perform a second iteration of the training session using the second candidate partition layer.

3. The first device of claim 2, wherein the instructions are further executable by the processor to cause the first device to:
obtain updated first performance information of the first device based at least in part on performing a threshold quantity of iterations of the training session; and
receive updated second performance information of the second device based at least in part on performing the threshold quantity of iterations, wherein the second candidate partition layer is selected based at least in part on the updated first performance information and the updated second performance information.

4. The first device of claim 2, wherein the second candidate partition layer is selected based at least in part on a gradient for updating a weight of the second candidate partition layer being less than a threshold gradient.

5. The first device of claim 1, wherein the first performance information and the second performance information each comprise latency information and power consumption information.

6. The first device of claim 1, wherein the instructions are further executable by the processor to cause the first device to:
transmit a request to partition the neural network model to the second device, wherein the second performance information is received based at least in part on transmitting the request.

7. The first device of claim 6, wherein the request is transmitted based at least in part on a processing capability of the first device.

8. The first device of claim 1, wherein the instructions are further executable by the processor to cause the first device to:
receive a request to partition the neural network model from the second device, wherein the first performance information is obtained based at least in part on receiving the request.

9. The first device of claim 1, wherein the instructions are further executable by the processor to cause the first device to:
transmit an indication of the candidate partition layer to the second device based at least in part on selecting the candidate partition layer.

10. The first device of claim 1, wherein the instructions are further executable by the processor to cause the first device to:
perform part of a training session iteration using the first sub-neural network model; and
transmit an output of the candidate partition layer to the second device based at least in part on performing part of the training session iteration.

11. The first device of claim 10, wherein the instructions are further executable by the processor to cause the first device to:
receive, from the second device based at least in part on transmitting the output, a second output of a second layer of the neural network model that is adjacent to the candidate partition layer; and
update one or more weights of the candidate partition layer based at least in part on the second output.

12. The first device of claim 1, wherein the instructions are further executable by the processor to cause the first device to:
receive an output of the candidate partition layer from the second device; and
perform part of a training session iteration using the first sub-neural network model based at least in part on the output of the candidate partition layer.

13. The first device of claim 12, wherein the instructions are further executable by the processor to cause the first device to:
transmit, to the second device, a second output, of a second layer of the neural network model that is adjacent to the candidate partition layer, for updating one or more weights of the candidate partition layer.

14. The first device of claim 1, wherein the instructions are further executable by the processor to cause the first device to:
perform part of a task using the first sub-neural network model, wherein the first sub-neural network model includes the candidate partition layer; and
transmit an output of the candidate partition layer to the second device for use by the second sub-neural network model.

15. A method for wireless communication at a first device, comprising:
obtaining first performance information of the first device associated with different candidate partition layers for partitioning a neural network model into a first sub-neural network model on the first device and a second sub-neural network model on a second device;
receiving second performance information of the second device associated with the different candidate partition layers for partitioning the neural network model; and
selecting, based at least in part on the first performance information and the second performance information, a candidate partition layer of the different candidate partition layers for partitioning the neural network model into the first sub-neural network model on the first device and the second sub-neural network model on the second device.

16. The method of claim 15, further comprising:
selecting, after performing a first iteration of a training session using the candidate partition layer, a second candidate partition layer for partitioning the neural network model; and
performing a second iteration of the training session using the second candidate partition layer.

17. The method of claim 16, further comprising:
obtaining updated first performance information of the first device based at least in part on performing a threshold quantity of iterations of the training session; and
receiving updated second performance information of the second device based at least in part on performing the threshold quantity of iterations, wherein the second candidate partition layer is selected based at least in part on the updated first performance information and the updated second performance information.

18. The method of claim 16, wherein the second candidate partition layer is selected based at least in part on a gradient for updating a weight of the second candidate partition layer being less than a threshold gradient.

19. The method of claim 15, wherein the first performance information and the second performance information each comprise latency information and power consumption information.

20. The method of claim 15, further comprising:
transmitting a request to partition the neural network model to the second device, wherein the second performance information is received based at least in part on transmitting the request.

21. The method of claim 20, wherein the request is transmitted based at least in part on a processing capability of the first device.

22. The method of claim 15, further comprising:
receiving a request to partition the neural network model from the second device, wherein the first performance information is obtained based at least in part on receiving the request.

23. The method of claim 15, further comprising:
transmitting an indication of the candidate partition layer to the second device based at least in part on selecting the candidate partition layer.

24. The method of claim 15, further comprising:
performing part of a training session iteration using the first sub-neural network model; and
transmitting an output of the candidate partition layer to the second device based at least in part on performing part of the training session iteration.

25. The method of claim 24, further comprising:
receiving, from the second device based at least in part on transmitting the output, a second output of a second layer of the neural network model that is adjacent to the candidate partition layer; and
updating one or more weights of the candidate partition layer based at least in part on the second output.

26. The method of claim 15, further comprising:
receiving an output of the candidate partition layer from the second device; and
performing part of a training session iteration using the first sub-neural network model based at least in part on the output of the candidate partition layer.

27. The method of claim 26, further comprising:
transmitting, to the second device, a second output, of a second layer of the neural network model that is adjacent to the candidate partition layer, for updating one or more weights of the candidate partition layer.

28. The method of claim 15, further comprising:
performing part of a task using the first sub-neural network model, wherein the first sub-neural network model includes the candidate partition layer; and
transmitting an output of the candidate partition layer to the second device for use by the second sub-neural network model.

29. An apparatus for wireless communication at a first device, comprising:
means for obtaining first performance information of the first device associated with different candidate partition layers for partitioning a neural network model into a first sub-neural network model on the first device and a second sub-neural network model on a second device;
means for receiving second performance information of the second device associated with the different candidate partition layers for partitioning the neural network model; and
means for selecting, based at least in part on the first performance information and the second performance information, a candidate partition layer of the different candidate partition layers for partitioning the neural network model into the first sub-neural network model on the first device and the second sub-neural network model on the second device.

30. A non-transitory computer-readable medium storing code for wireless communication at a first device, the code comprising instructions executable by a processor to:
obtain first performance information of the first device associated with different candidate partition layers for partitioning a neural network model into a first sub-neural network model on the first device and a second sub-neural network model on a second device;
receive second performance information of the second device associated with the different candidate partition layers for partitioning the neural network model; and
select, based at least in part on the first performance information and the second performance information, a candidate partition layer of the different candidate partition layers for partitioning the neural network model into the first sub-neural network model on the first device and the second sub-neural network model on the second device.
